(19) United States
(12) Patent Application Publication
(10) Pub. No.: US 2004/0208585 A1
(43) Pub. Date: Oct. 21, 2004

(54) Systems and methods for minimizing signal power and providing reduced Raman pump depletion for WDM optical system

(75) Inventor: Jinendra Kumar Ranka, Brookline, MA (US)

Correspondence Address: LAHIVE & COCKFIELD, LLP., 28 STATE STREET, BOSTON, MA, 02109, US

(73) Assignee: Sycamore Networks, Inc., Chelmsford, MA

(21) Appl. No.: 10/103,160

(22) Filed: Mar. 20, 2002

(51) Int. Cl. H04J 14/02; H01S 3/00

(52) U.S. Cl. 398/92; 359/334

(57) ABSTRACT

An optical transmission system with two counter propagating wavelength division multiplexed (WDM) optical signals carried by an optical fiber transmission line, has a first Raman pump for launching a first beam of pump energy for amplifying both WDM signals so that the first beam counter-propagates with respect to a first WDM signal The system also includes a second Raman pump for launching a second beam of pump energy for amplifying both WDM signals so that the second beam counter-propagates with respect to a second WDM signal.

### CROSS REFERENCE TO RELATED APPLICATIONS

Not Applicable.

### STATEMENT REGARDING FEDERALLY SPONSORED RESEARCH

Not Applicable.

### REFERENCE CITED

1. U.S. Pat. No. 6,163,636, A. J. Stentz et al.—Optical communication system using multiple-order Raman amplifiers

2. U.S. Pat. No. 6,181,464, David H. Kidorf et al.—Low noise Raman amplifier employing bidirectional pumping and an optical transmission system incorporating same

3. IEC (International Engineering Forum) Tutorial—Raman Amplification Design in WDM Systems (http://www.iec.org/online/tutorials/raman/topic05.html)

### FIELD OF THE INVENTION

This invention relates generally to optical amplifiers and more particularly to systems and methods for signal transmission utilizing both co- and counter-propagating distributed Raman amplification in a Wavelength Division Multiplexing (WDM) optical communication system.

### BACKGROUND OF THE INVENTION

WDM is a technology for optical communications which uses packed wavelengths of light to effectively multiply the capacity of the fiber. Each wavelength carries a distinct signal. The performance of such systems is limited by optical attenuation which progressively weakens the optical strength of the signals as they propagate along the fiber. WDM optical communication systems are practical because of the use of optical amplifiers which restore the strength of signals of all wavelengths simultaneously, to counteract the effects of optical attenuation. Amplifiers are typically selected to provide enough amplification to restore the signal but not more than necessary to restore the signal. Too much amplification would upset the gain balance, causing an ever increasing signal.

The most commonly deployed optical amplifier the Erbium-Doped Fiber Amplifier (EDFA). An EDFA amplifies wavelengths of light within a large frequency. However, although its frequency space is large, it is relatively small compared with the total bandwidth of the low loss window of the optical fiber. Thus, the EDFA bandwidth generally restricts the usable bandwidth. It is a fundamental property of optical amplifiers that in addition to delivering signal gain which strengthens the signals, they also produce noise (including amplified spontaneous emission, ASE) which degrades the signal.

As is known in the art, distributed Raman amplifiers in optical communication systems function by injecting a high-power optical beam into the transmission fiber. Through Stimulated Raman Scattering, energy is transferred from the Raman pump laser to the signals as they propagate in the fiber. Stimulated Raman scattering is an inelastic scattering process in which an incident pump photon loses its energy to create another photon of reduced energy at a lower frequency. The remaining energy is absorbed by the fiber medium in the form of molecular vibrations (i.e., optical phonons). That is, pump energy of a given wavelength amplifies a signal at a longer wavelength. The maximum gain occurs when the signal is at a frequency approximately 13 THz lower than the frequency of the pump. The frequency (or wavelength) difference between the pump and the frequency (or wavelength) of maximum gain is often referred to as the Stokes shift, and the amplified signal is referred to as the Stokes wave. Use of a pump that is detuned from the signals by about one Stokes shift (½ the Stoke shift to 3/2 the shift) is referred to as first-order Stokes pumping, and a pump beam with a wavelength that is about one Raman Stokes order below the first-order Raman pump is referred as second-order Stokes pumping.

As distinct from Erbium-Doped Fiber Amplifiers, distributed Raman amplification require no special dopants (such as erbium) to produce gain. Signals experience the gain not just in the vicinity of the pump but also over an appreciable length of fiber. Raman amplifiers are topologically simpler to design than doped-fiber amplifiers, as the existing transmission fiber can be used as a medium if properly pumped. However, the selection of pump powers and wavelengths, as well as the number and separation of pumps, strongly determines the wavelength behavior of Raman gain and noise.

The magnitude of the Raman gain, and thus the reduction in noise accumulation, increases as the Raman pump power is increased. In practical optical communications systems, however, there are limits to the reductions in noise accumulation which can be achieved with Raman amplification. One limitation arises from the problems associated with the high power required to produce large Raman gains in transmission fibers which also depends on the characteristics of the fiber. Another problem with Raman amplification is that the high signal powers will result in signal-induced Raman pump depletion which is the reduction of Raman pump power due to energy transfer to the signal. This is most significant in systems that utilize co-propagating Raman amplification, where the signals are launched into the fiber together with a Raman pump. A system that was initially balanced such that the net amplifier gain (EDFA+Raman) equaled the total losses will become unbalanced as the number of channels transmitted in the system is increased or decreased, changing the degree of pump depletion and altering the net Raman gain experienced. As the interaction length is over several kilometers of fiber, rather than a few meters as with erbium doped fiber amplifiers, the pump depletion is difficult to detect and control.

Raman amplification that employs multiple order Raman pumping where the co-propagating pump amplifies the counter-propagating pump is described in [1] U.S. Pat. No. 6,163,636, issued to John A. Stentz et al. and in [2] U.S. Pat. No. 6,181,464, issued to David H. Kidorf et al.. In [3], a system with distinct C-band (Conventional band) and L-band (Long wavelength band) Raman pump which are specifically selected to mainly amplify (in counter-propagating configuration) an L-band signal and a C-band signal is disclosed. The signals get residual amplifications from co-propagating Raman pumps and power exchange between two Raman pumps, enhances the Raman depletion.

It would, therefore, be desirable to provide a system architecture for WDM optical network with distributed Raman amplification that minimizes signal power so as to decrease the Raman pump depletion.

It would also be desirable to provide a method of gain control for co-propagating Raman amplification so as to maintain constant amplifier gain.

It would also be desirable to provide methods of Raman gain monitoring for constant Raman gain control.

### SUMMARY OF THE INVENTION

The present invention provides systems and methods for a WDM optical network with distributed Raman amplification that minimizes signal power and reduces Raman depletion.

An optical transmission system has two counter propagating WDM optical signals carried by an optical fiber transmission line. The optical transmission system has a first Raman pump for launching a first beam of pump energy to amplify both WDM signals so that the first beam of pump energy counter-propagates with respect to the first WDM signal. The optical transmission system also includes a second Raman pump for launching a second beam of pump energy for amplifying both WDM signals so that the second beam of pump energy counter-propagates with respect to the second WDM signal.

A method for amplifying in an optical system that has two counter propagating WDM optical signals carried by an optical fiber transmission line introduces a first beam of pump energy for amplifying both WDM signals so that the first beam of pump energy counter-propagates with respect to the first WDM signal. The method also introduces a second beam of pump energy for amplifying both WDM signals so that the second beam of pump energy counter-propagates with respect to the second WDM signal.

An optical transmission system with two counter propagating WDM optical signals carried by an optical fiber transmission line, has a Raman pump for launching a beam of pump energy for amplifying both WDM signals so that the beam of pump energy counter-propagates with respect to one of the WDM signals.

A method for amplifying optical system having two counter propagating WDM optical signals carried by an optical fiber transmission line, introduces a beam of pump energy for amplifying the both WDM signals so that the beam of pump energy counter-propagates with respect to one of the WDM signals.

An optical transmission system with a WDM optical signal carried by an optical fiber transmission line, has a first Raman pump for launching a beam of pump energy for amplifying the WDM optical signal so that the beam of pump energy co-propagates with respect to the WDM signal. The optical transmission system also includes a second Raman pump for launching a beam of pump energy for amplifying the first Raman pump beam so that the beam of pump energy co-propagates with respect to both the WDM signal and the first Raman pump beam

A method for amplifying optical system having a WDM optical signal carried by an optical fiber transmission line, routes the WDM signal on the optical fiber transmission line, introduces a first beam of pump energy for amplifying the WDM signal so that the first beam of pump energy co-propagates with respect to the WDM signal, and then introduces a second beam of pump energy for amplifying the first beam of pump so that the second beam of pump energy co-propagates with respect to both the WDM signal and the first beam of pump.

A method for Raman gain monitoring for an optical system having an Raman pump beam co-propagating with respect to a WDM optical signal carried by an optical fiber transmission line, measures the power of back-reflected portion of the Raman pump beam and adjusts the Raman pump power to maintain constant power for the back-reflected portion of the Raman pump beam.

A method for Raman gain monitoring for an optical system having an Raman pump beam co-propagating with respect to a WDM optical signal carried by an optical fiber transmission line, measures the power of back-reflected portion of the WDM signal. and adjusts the Raman pump power to maintain constant of back-reflected portion of the WDM signal.

### BRIEF DESCRIPTION OF THE DRAWINGS

The invention will be more fully understood from the following detailed description taken in conjunction with the accompanying drawings, in which:

FIG. 1 is a schematic diagram of a conventional hybrid EDF/Raman amplified WDM optical fiber communication system with counter-propagating Raman amplification.

FIG. 2 is a schematic representation of a conventional bidirectionally Raman amplified WDM system configuration which uses multiple-order Raman pumps

FIG. 3 is an embodiment for a bidirectionally Raman amplified WDM system in accordance with present invention

FIG. 4 is a schematic representation of an embodiment for a Raman amplified WDM system in accordance with present invention

FIG. 5 is an embodiment for gain control for co-propagating Raman amplified WDM system in accordance with present invention

FIG. 6 is an embodiment for a bidirectionally Raman amplified WDM system with Raman gain monitoring in accordance with present invention

### DETAILED DESCRIPTION OF THE INVENTION

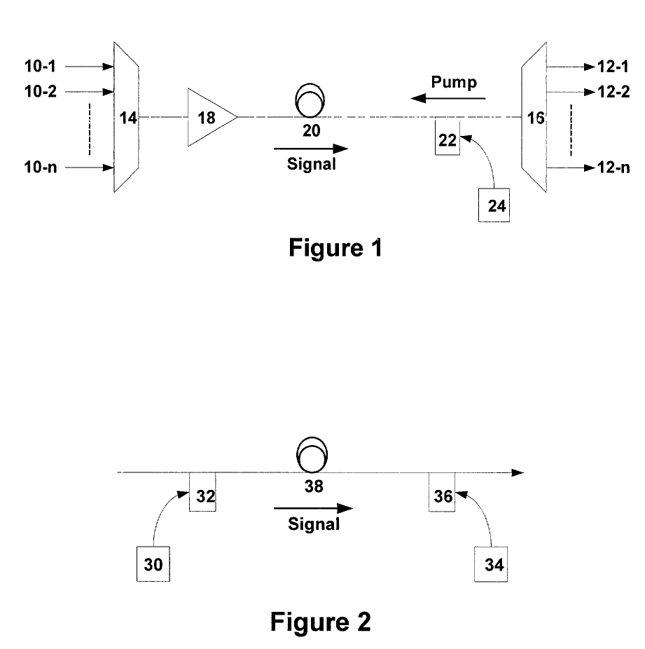

Referring to the drawings, FIG. 1 schematically illustrates a typical conventional hybrid EDF/Raman amplified WDM optical fiber communication system with a counter-propagating Raman amplification configuration. The system receives a plurality of input information-carrying optical signals carried on channels 10-1, 10-2, 10-n. The multiple channel signals 10-1, 10-2, and 10-n are combined by a multiplexer 14 and then amplified by an EDFA 18 before the signals sent onto a transmission fiber 20. Near the end of the fiber span, a Raman pump source 24, such as a laser, is injected into the transmission fiber 20 via a coupler 22, such as a multiplexer. The Raman pump beam travels in a counter-propagating direction with respect to the signal as indicated by the arrow labeled “Pump” in FIG. 1. The signal components 12-1, 12-2 and 12-n are then extracted by a demultiplexer 16. As previously mentioned, other arrangements such as co-propagating and bi-directional propagating configurations can be employed.

The power of a strong Raman pump in amplifying a weak signal will decrease exponentially with of distance as the light propagates into the transmission fiber due to fiber loss. This means that regardless of how powerful the pump, most of the amplification occurs relatively near the point where the pump is injected into the fiber (typically within 20 km). This significantly limits the improvement in the signal-to-noise ratio that the Raman pump can induce. As the pump power is increased, Rayleigh scattering of the signal limits the improvement in the signal-to-noise ratio.

FIG. 2 illustrates a bidirectionally Raman amplified WDM system configuration which uses a high order Raman pump to amplify the counter-propagating first order Raman pump. As illustrated in FIG. 2, pump source 34, such as a laser, provides a pump beam via a coupler 36, such as a multiplexer, that travels in a counter-propagating direction with respect to the signal and pump source 30 that provides a pump beam via a coupler 32, such as a multiplexer, that travels in a co-propagating direction with respect to the signal which travels on the transmission fiber 38. The pump sources 30 and 34 are specifically selected so that pump source 34 (which is a first order Raman pump) will amplify the signal and pump source 30 (which is a second order Raman pump) will amplify the pump beam from pump source 34. The second order Raman pump 30 is adjusted to maintain constant Raman gain. Although the arrangement in FIG. 2 can boost the power of the first order Raman pump 34, for WDM system, due to the high signal power, the Raman depletion issue is still there.

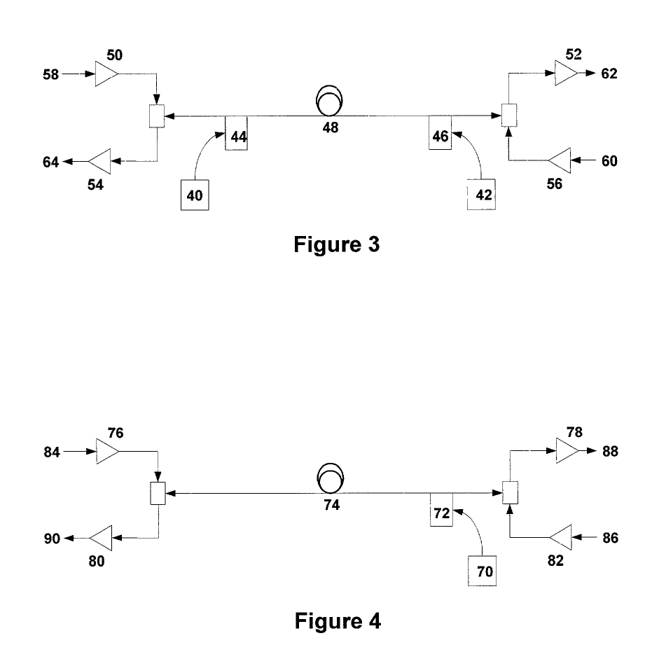

As illustrated in FIG. 3, in accordance with one aspect of the invention, a WDM optical fiber communication system has two WDM optical signals that are carried over an optical fiber transmission line. The system includes two Raman amplifiers. The first Raman amplifier 40 via a coupler 44 is disposed to co-propagate with a first WDM signal 58 which is first amplified by an optical amplifier 50 (such as an EDFA) before being introduced to the transmission fiber 48, and the second Raman amplifier 42 via a coupler 46 is disposed to co-propagate with a second WDM signal 60, which is first amplified by an optical amplifier 56 (such as an EDFA) before being introduced to the transmission fiber 48. The two WDM signals 58 and 60 are further amplified by optical amplifiers 52 and 54 after leaving fiber span 48 before being output as outputs 62 and 64. The two WDM signals 58 and 60 travel in opposite directions.

The two WDM signals can take a variety of forms, such as one or multiple is wavelengths (subband) C-band WDM signal and one or multiple wavelengths (subband) L-band WDM signal, or the odd number channels of C-band signals and even number channels of C-band signals, or other possible arrangements. Compared to conventional approach of transmitting all WDM signal together in one direction (such as transmitting all C-band and L-band in one direction), which requires much higher signal power, the arrangement in FIG. 3, which transmits two WDM signals on the opposite directions, can minimize the signal power of the signals so as to reduce the signal-induced Raman depletion. In addition, the two Raman pumps 40 and 42 have a gain bandwidth such that two Raman pump beams amplify both WDM signals. For illustrative purpose, assume WDM signal 58 is in the C-band and WDM signal 60 is in the L-band. The wavelength for the Raman pump 40 and 42 can be chosen as 1440, 1455, or 1487 nm, among many possible choices. This is different from the conventional arrangements in the art that either use the co-propagating Raman pump to amplify the counter-propagating Raman pump which further amplifies the signal or use one Raman pump to amplify signal in a first direction and another Raman pump to amplify signal in a second direction, where one Raman pump is used as a primary pump source for signal in one direction. In contrast, signal powers in FIG. 3 can be lowered because the signal launched at either end of fiber gets amplified by both Raman pumps (one in co-propagating, the other in counter-propagating). The extra gain from the additional Raman pump facilitates lowering signal powers, which further reduces the signal-induced Raman depletion due to high signal powers. Another benefit from FIG. 3 configuration is the relatively constant distribution of Raman pump power over the transmission fiber due to following characteristics of the invention: lower signal power of the signals due to the bi-directional arrangement and reduced Raman depletion.

For some fiber plants which may not support the use of co-propagating Raman amplification for signals with specific wavelengths, such as C-band, due to noise, a single Raman pump which amplifies signals in both directions can be used as shown in FIG. 4. Assume that the fiber plant 74 does not support the use of co-propagating Raman amplification for WDM signal 84. The Raman pump 70 amplifies WDM signal 84 in a counter-propagating way in one direction and WDM signal 86 in a co-propagating way in another direction. This configuration also has the benefit of reduced Raman depletion from lower signal powers due to the transmission of two WDM signals in two opposite directions.

Depending on customer requirements, additional wavelengths can be inserted into the system, and some wavelengths can be removed from the system. Either of these cases changes the degree of pump depletion and alters the net Raman gain (EDFA+Raman) experienced. The net result is an adverse impact on system performance. A solution to this problem is to adjust the Raman pump power according to the launched signal power such that the net Raman gain achieved does not change. This can be done either by directly increasing the Raman pump power or by adjusting the power of a second order Raman pump, that provides Raman gain to the primary Raman pump, to compensate for the signal-induced primary Raman pump depletion, which will minimize the impact on system performance compared to the directly adjustment approach.

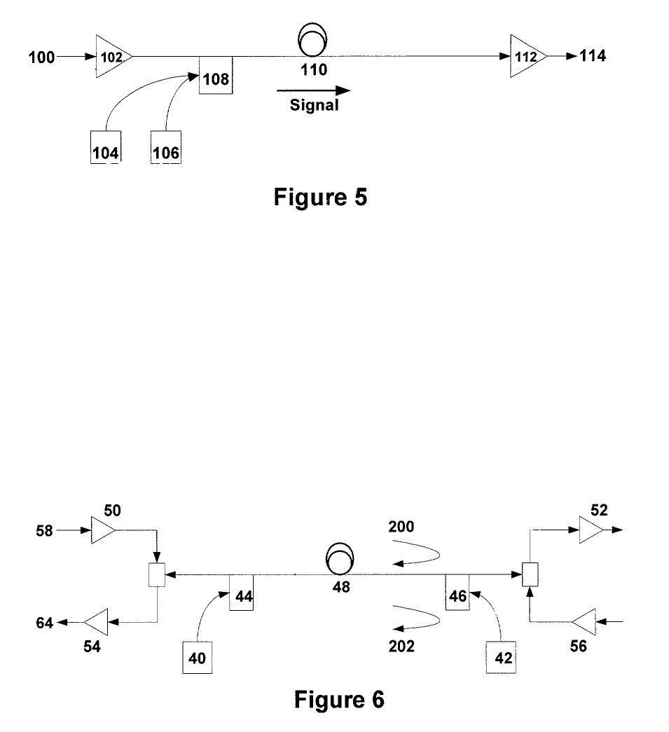

As shown in FIG. 5, in accordance with another aspect of the present invention, a co-propagating Raman amplified WDM transmission system, includes a first Raman pump 106 (such as a first-order Raman pump) which amplifies the WDM signal 100 that is first amplified by an optical amplifier 102 (such as an EDFA) before the WDM signal is introduced to the transmission fiber 110. The Raman pump beam 106 is coupled to the transmission fiber 110 via coupler 108 (e.g. a multiplexer) and travels in the same direction as the WDM signal 100. A second Raman pump 104 (such as a second-order Raman pump) is used to amplify the first Raman pump 106 but not the WDM signal 100. After leaving the transmission fiber 110, the WDM signal 100 is post-amplified by another optical amplifier 112 before being output as output signal 114. Although the same configuration can be used for co-propagating, counter-propagating, and bi-directional propagating Raman amplification, for illustrative purposes, what is shown in FIG. 5 is just for a co-propagating configuration since Raman depletion is much more significant for co-propagating configuration where the Raman pump is launched with a strong signal hence the than for the counter-propagating configuration where the depletion is small.

As was mentioned above, when the launched signal power increases, the depletion of the co-propagating Raman pump increases. To be able to maintain constant Raman gain, the Raman pump depletion has to be monitored accurately. The relative power of the Raman pump or the magnitude of the Raman gain can be determined by following two methods. For illustrative purposes, FIG. 6 shows an embodiment of Raman gain monitoring for a bi-directional Raman configuration (which is identical to FIG. 3 other than the back-reflected signal 200 and backreflected signal Raman pump 202. As illustrated in FIG. 6, to use signal 58 as an example, the Raman depletion can be determined: 1) by measuring the power of back-reflected signal 200 from the fiber span. The measured signal power can then be compared to the launched signal power. The back-reflected signal 200 will be proportional to the co-propagating Raman gain as it is amplified by the Raman pumped section of the transmission fiber twice, once in the forward direction by Raman pump 40 in the form of the signal and once in the backward direction by Raman pump 42 as a back-reflected signal from the span. 2) by measuring the power of back-reflected pump beam 202 from the fiber span when the signal induced depletion is minimized. Given that the power of back-reflected Pump beam 202 is proportional to the Raman pump power in the fiber span, as the signal induced pump depletion increases, the amount of backreflected pump power decreases. By altering the launched pump power (as illustrated in FIG. 5) in order to maintain either a constant level of backreflected pump power or a level (can be determined a priori) that is dependent on the level of launched signal power, the level of Raman gain can be maintained constant.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. An optical transmission system having an optical fiber transmission line, comprising:
a first wavelength division multiplexed (WDM) signal transmitting in a first direction along said optical fiber transmission line;
a second WDM signal transmitting in a second direction opposite to said first direction along said optical fiber transmission line;
a first Raman pump for launching a first beam of pump energy at a first wavelength for amplifying said first WDM signal and said second WDM signal so that the first beam of pump energy counter-propagates with respect to said first WDM signal;
a second Raman pump for launching a second beam of pump energy at a second wavelength for amplifying said first WDM signal and said second WDM signal so that the second beam of pump energy counter-propagates with respect to said second WDM signal.

2. The optical transmission system in claim 1 wherein said two WDM signals, one from C-band, one from L-band.

3. The two WDM signals in claim 2, one said signal includes one or more C-band wavelengths and another said signal includes one or more L-band wavelengths.

4. The optical transmission system in claim 1 wherein said two WDM signals are from same signal band.

5. The signal band in claim 4 is C-band, L-band or S-band.

6. The two WDM signals in claim 4, one said signal includes one or more odd channel wavelength and another said signal includes one or more even channel wavelength wavelengths.

7. The optical transmission system in claim 1 wherein said first wavelength for said first beam of pump energy and said second wavelength for said second beam of pump energy are the same.

8. A method of amplifying an optical system having two counter propagating WDM optical signals carried by an optical fiber transmission line, comprising the steps of:
routing a first wavelength division muliplexed (WDM) signal in a first direction on said optical fiber transmission line;
routing a second WDM signal in a second direction opposite to said first direction on said optical fiber transmission line;
introducing a first beam of pump energy to said optical fiber transmission line at a first wavelength for amplifying said first WDM signal and said second WDM signal so that the first beam of pump energy counter-propagates with respect to said first WDM signal;
introducing a second beam of pump energy to said optical fiber transmission line at a second wavelength for amplifying said first WDM signal and said second WDM signal so that the second beam of pump energy counter-propagates with respect to said second WDM signal.

9. An optical transmission system comprising:
An optical fiber transmission line for carrying a first wavelength division multiplexed (WDM) signal in a first direction and a second WDM signal in a second direction opposite to said first direction;
a Raman pump for launching a beam of pump energy at a wavelength for amplifying said first WDM signal and said second WDM signal so that the beam of pump energy counter-propagates with respect to said first WDM signal.

10. The optical transmission system in claim 9 wherein said first and second WDM signals include a C-band signal and an L-band signal.

11. The optical transmission system in claim 9 wherein said first and second WDM signals include an odd channel and an even channel from an optical signal band.

12. The optical transmission system in claim 9 wherein said optical fiber transmission line does not support co-propagating of said pump beam energy with respect to said first WDM signal.

13. The optical transmission system in claim 11 wherein said optical signal band is selected from the group consisting of the C-band, the L-band and the S-band.

14. A method of amplifying in an optical system having two counter propagating WDM optical signals carried by an optical fiber transmission line, comprising steps of:
routing a first wavelength division multiplexed (WDM) signal in a first direction on said optical fiber transmission line;
routing a second WDM signal in a second direction opposite to said first direction on said optical fiber transmission line;
introducing a beam of pump energy at a wavelength for amplifying said first WDM signal and said second WDM signal to said optical fiber transmission line so that the beam of pump energy counter-propagates with respect to said first WDM signal.

15. An optical transmission system with a wavelength division multiplexed (WDM) optical signal carried by an optical fiber transmission line, comprising:
a first Raman pump for launching a first beam of pump energy at a first wavelength for amplifying said WDM signal so that said first beam of pump energy co-propagates with respect to said WDM signal;
a second Raman pump for launching a second beam of pump energy at a second wavelength for amplifying said first beam of pump energy so that said second beam of pump energy co-propagates with respect to both said WDM signal and said first beam.

16. The optical transmission system in claim 15 wherein said first wavelength for said first Raman pump is chosen so that the first beam of pump energy amplifies said WDM signal.

17. The optical transmission system in claim 15 wherein said first wavelength for said first Raman pump is chosen so that the first Raman pump is a first order Raman pump for amplifying said WDM signal.

18. The optical transmission system in claim 15 wherein said second wavelength for said second Raman pump is chosen so that the second beam of pump energy amplifies said first beam of pump energy but not said WDM signal.

19. The optical transmission system in claim 15 wherein said second wavelength for said second Raman pump is chosen so that said second Raman pump is a second order Raman pump for amplifying said first beam of pump energy but not said WDM signal.

20. A method of amplifying in an optical system having a WDM optical signal carried by an optical fiber transmission line, comprising the steps of:
routing said wavelength division multiplexed (WDM) signal on said optical fiber transmission line;
introducing a first beam of pump energy to said optical fiber transmission line at a first wavelength for amplifying said WDM signal so that the first beam of pump energy co-propagates with respect to said WDM signal;
introducing a second beam of pump energy to said optical fiber transmission line at a second wavelength for amplifying said first beam of pump so that the second beam of pump energy co-propagates with respect to both said WDM signal and said first beam of pump; and
adjusting power of said second beam of pump energy.

21. The method according to claim 20 wherein said step of adjusting power of said second beam of pump energy is based on launched signal power change.

22. The method according to claim 20 wherein said step of adjusting power of said second beam of pump energy maintains constant net amplifier gain.

23. A method for Raman gain monitoring for an optical system having an Raman pump beam co-propagating with respect to a wavelength division multiplexed (WDM) optical signal carried by an optical fiber transmission line, comprising the steps of:
measuring power of a back-reflected portion of said Raman pump beam;
adjusting said Raman pump power to maintain constant said power of the back-reflected portion of said Raman pump beam.

24. A method for Raman gain monitoring for an optical system having an Raman pump beam co-propagating with respect to a wavelength division multiplexed (WDM) optical signal carried by an optical fiber transmission line, comprising the steps of:
measuring power of a back-reflected portion of said WDM signal;
adjusting power of said Raman pump beam to maintain constant said power of backreflected portion of said WDM signal.
